(19) United States
(12) Patent Application Publication
(10) Pub. No.: US 2026/0050164 A1
(43) Pub. Date: Feb. 19, 2026

(54) HEAD-MOUNTED DISPLAY DEVICE AND ZOOM LENS MODULE

(71) Applicant: HTC Corporation, Taoyuan City (TW)

(72) Inventors: Chih-Hsiang Hsieh, Taoyuan City (TW); Li-Hsun Chang, Taoyuan City (TW)

(73) Assignee: HTC Corporation, Taoyuan City (TW)

(21) Appl. No.: 19/023,325

(22) Filed: Jan. 16, 2025

Related U.S. Application Data
(60) Provisional application No. 63/682,801, filed on Aug. 14, 2024.

(51) Int. Cl. G02B 27/01; G02B 15/14

(52) U.S. Cl. CPC G02B 27/0172; G02B 15/14

(57) ABSTRACT

A head-mounted display device and zoom lens module are provided. The zoom lens module includes a base, a first lens frame, a first lens, a flexible zoom band, a second lens frame and a second lens. The first lens frame is slidably assembled to the base. An outer peripheral wall of the first lens frame has various curvature radii. The flexible zoom band surrounds the outer peripheral wall. A guide block of the flexible zoom band is embedded in an oblique guide groove of the outer peripheral wall and is adapted to slide along the oblique guide groove. The second lens frame is assembled to the base. The first lens frame is located between the base and the second lens frame. The flexible zoom band is located between the second lens frame and the first lens frame. A sliding rod of the flexible zoom band passes through a circumferential groove of the second lens frame and is adapted to slide along the circumferential groove. When the flexible zoom band slides on the outer peripheral wall, the guide block drives the first lens frame to slide in a zoom direction.

### CROSS-REFERENCE TO RELATED APPLICATION

The application claims the priority benefit of U.S. provisional application Ser. No. 63/682,801, filed on Aug. 14, 2024. The entirety of the above-mentioned patent application is hereby incorporated by reference herein and made a part of this specification.

### BACKGROUND

### Technical Field

The application relates to a head-mounted display device and a lens module, and in particular, to a head-mounted display device and a zoom lens module.

### Description of Related Art

With the rapid advancement of current technology, the types and functions of head-mounted display devices are becoming increasingly diversified. Take a goggle-type head-mounted display device as an example, the gyroscope and position tracker inside the head-mounted display device may track the user's movement to display the corresponding scene image when a user wears such a device, thereby providing the users with an experience as if they are in a virtual world.

When using the head-mounted display device, since each user has different degrees of myopia, two zoom lens modules can be provided in the head-mounted display device to suit different users, so that each user can get the best user experience. Currently, zooming is performed by rotating a circular zoom ring to drive the circular lens assembled in the zoom ring to rotate and move. However, when the area of the lens is enlarged or the user's eyes are moved closer to the lens in order to increase the viewing angle, the possibility of the zoom lens modules pressing on the user's nose and brow bone also increases. If the lens is modified to be non-circular in order to solve this problem, the zoom ring will not be able to rotate because it appears non-circular.

### SUMMARY

The application provides a head-mounted display device and a zoom lens module, which can solve the problem of being unable to zoom with the non-circular zoom ring.

The head-mounted display device of the application includes a body, a fixing device, and two zoom lens modules. The body has two displays corresponding to both eyes. The fixing device is adapted to fix the body to a user's head. Each of the zoom lens modules includes a base, a first lens frame, a first lens, a flexible zoom band, a second lens frame and a second lens. The base is assembled to the body and corresponds to one of the two displays. The first lens frame is slidably assembled to the base. The first lens frame is adapted to slide relative to the base along a zoom direction. An outer peripheral wall of the first lens frame has various curvature radii. The outer peripheral wall has an oblique guide groove. The first lens is assembled to the first lens frame. The flexible zoom band surrounds the outer peripheral wall and is adapted to slide snugly on the outer peripheral wall. The outside of the flexible zoom band has a sliding rod. The inside of the flexible zoom band has a guide block. The guide block is embedded in the oblique guide groove and is adapted to slide along the oblique guide groove. The second lens frame is assembled to the base. The first lens frame is located between the base and the second lens frame. The flexible zoom band is located between the second lens frame and the first lens frame. The second lens frame has a circumferential groove. The sliding rod passes through the circumferential groove and is adapted to slide along the circumferential groove. The second lens is assembled to the second lens frame. When the sliding rod is driven by force to drive the flexible zoom band to slide on the outer peripheral wall, the guide block drives the first lens frame to slide in the zoom direction.

The zoom lens module of the application includes a base, a first lens frame, a first lens, a flexible zoom band, a second lens frame and a second lens. The first lens frame is slidably assembled to the base. The first lens frame is adapted to slide relative to the base along a zoom direction. An outer peripheral wall of the first lens frame has various curvature radii. The outer peripheral wall has an oblique guide groove. The first lens is assembled to the first lens frame. The flexible zoom band surrounds the outer peripheral wall and is adapted to slide snugly on the outer peripheral wall. The outside of the flexible zoom band has a sliding rod. The inside of the flexible zoom band has a guide block. The guide block is embedded in the oblique guide groove and is adapted to slide along the oblique guide groove. The second lens frame is assembled to the base. The first lens frame is located between the base and the second lens frame. The flexible zoom band is located between the second lens frame and the first lens frame. The second lens frame has a circumferential groove. The sliding rod passes through the circumferential groove and is adapted to slide along the circumferential groove. The second lens is assembled to the second lens frame. When the sliding rod is driven by force to drive the flexible zoom band to slide on the outer peripheral wall, the guide block drives the first lens frame to slide in the zoom direction.

Based on the above, in the head-mounted display device and the zoom lens module of the application, the flexible zoom band can be used to slide on the outer peripheral wall of the non-circular first lens frame and drive the lens to slide in the zoom direction to achieve the purpose of zooming.

### BRIEF DESCRIPTION OF THE DRAWINGS

FIG. 1 is a schematic diagram of a head-mounted display device according to an embodiment of the present invention.

FIG. 2 is a schematic diagram of a disassembled state of a zoom lens module and a display of the head-mounted display device of FIG. 1.

FIG. 3 is a front view of a first lens frame of the zoom lens module of FIG. 2.

FIG. 4 is a front view of a band body of a flexible zoom band of the zoom lens module of FIG. 2.

FIG. 5 is a schematic diagram of the zoom lens module of FIG. 2 after partial assembly.

FIG. 6 is a schematic diagram of another viewing angle of the zoom lens module of FIG. 5 after being partially assembled again.

FIG. 7 is a partial perspective view of the zoom lens module of FIG. 2 in one state.

FIG. 8 is a cross-sectional view of the zoom lens module of FIG. 7.

FIG. 9 is a partial perspective view of the zoom lens module of FIG. 2 in another state.

FIG. 10 is a cross-sectional view of the zoom lens module of FIG. 9.

### DESCRIPTION OF THE EMBODIMENTS

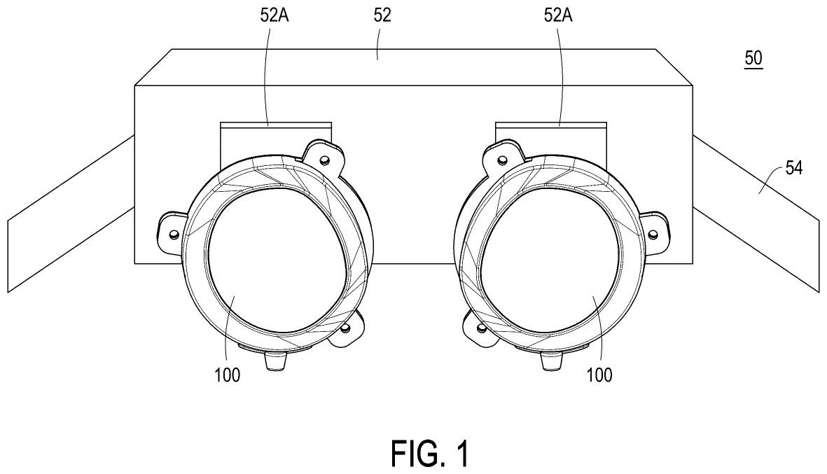

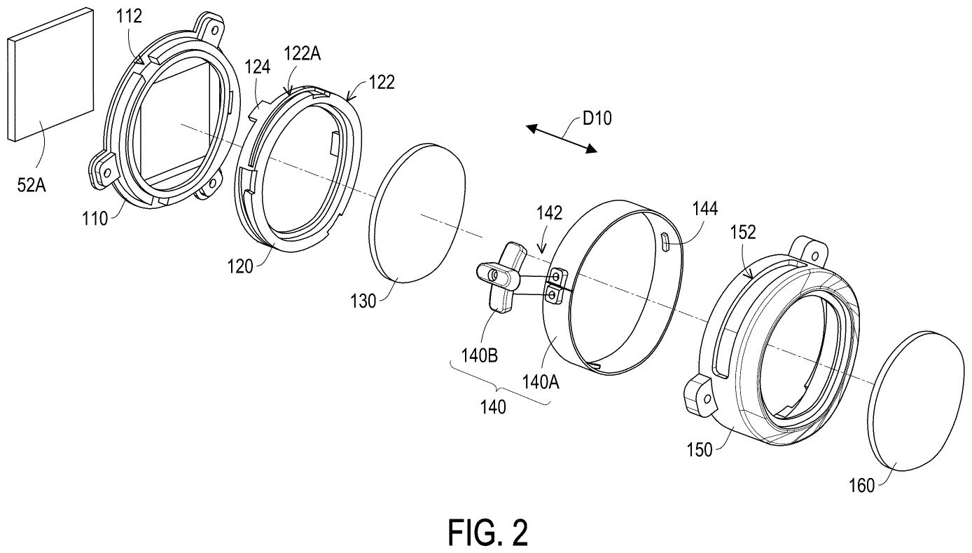

FIG. 1 is a schematic diagram of a head-mounted display device according to an embodiment of the present invention. FIG. 2 is a schematic diagram of a disassembled state of a zoom lens module and a display of the head-mounted display device of FIG. 1. Referring to FIG. 1 and FIG. 2, the head-mounted display device 50 of the embodiment includes a body 52, a fixing device 54 and two zoom lens modules 100. The body 52 has two displays 52A corresponding to both eyes. The fixing device 54 is adapted to fix the body 52 to a user's head. Each zoom lens module 100 includes a base 110, a first lens frame 120, a first lens 130, a flexible zoom band 140, a second lens frame 150, and a second lens 160. Each base 110 is assembled to the body 52 and corresponds to one of the displays 52A.

In the embodiment, the body 52 is a head-mounted display device, which can be applied to fields such as virtual reality system, augmented reality system or mixed reality system. In addition to the zoom lens module 100, the body 52 may also include other optical systems and protective housing components. The fixing device 54 of the embodiment is a temple, but in other embodiments the fixing device may also be a headband or other fixing device for fixing the body 52 to the user's head.

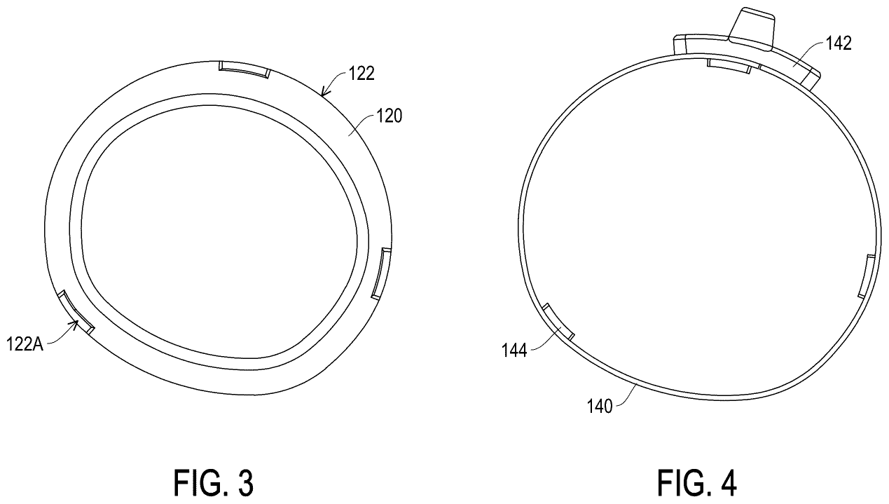

FIG. 3 is a front view of a first lens frame of the zoom lens module of FIG. 2. FIG. 4 is a front view of a band body of a flexible zoom band of the zoom lens module of FIG. 2. Referring to FIG. 3 and FIG. 4, an outer peripheral wall 122 of the first lens frame 120 of the embodiment has various curvature radii. That is, the outer peripheral wall 122 is not a perfect circle, because it matches the shape of the first lens 130. For example, the outer peripheral wall 122 of the embodiment is irregular in shape, and its curvature radii is gradual, but the application is not limited thereto. Because the outer peripheral wall 122 of the first lens frame 120 has various curvature radii, the traditional zoom ring that is rigid and has a perfect circular appearance cannot be used to drive the first lens frame 120 to move. However, the flexible zoom band 140 of the embodiment is flexible and can be bent, so the flexible zoom band 140 can surround the outer peripheral wall 122 and be adapted to slide snugly on the outer peripheral wall 122. Therefore, the flexible zoom band 140 of the embodiment can rotate relative to the first lens frame 120, and is used to drive the first lens frame 120 to move in a zoom direction D10.

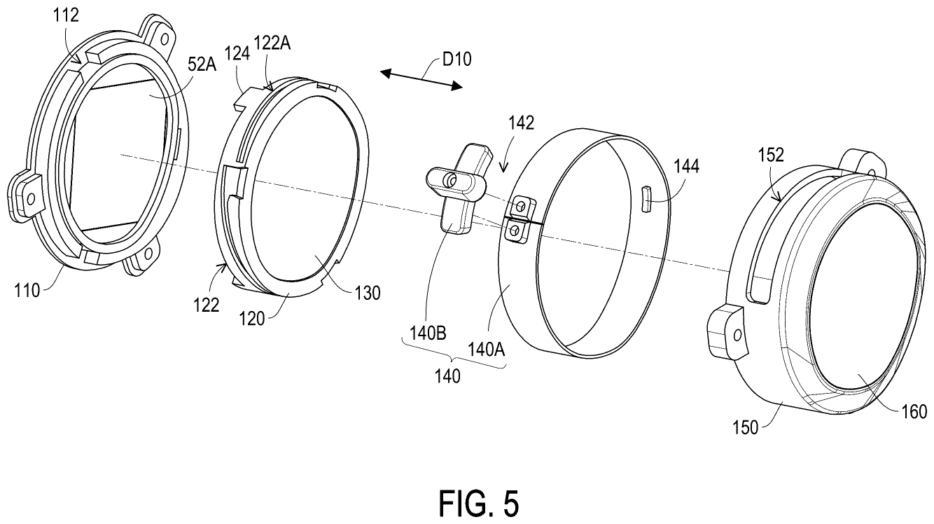

FIG. 5 is a schematic diagram of the zoom lens module of FIG. 2 after partial assembly. Referring to FIG. 2 and FIG. 5, the base 110 of the embodiment has, for example, a space for accommodating the display 52A, thereby fixing the relative positions of the base 110 and the display 52A. The first lens 130 is assembled to the first lens frame 120 to fix the relative position of the first lens 130 and the first lens frame 120, and the first lens 130 can move with the first lens frame 120. The second lens 160 is assembled to the second lens frame 150 to fix the relative position of the second lens 160 and the second lens frame 150. The first lens 130 can be composed of one or more lenses, and the second lens 160 can also be composed of one or more lenses.

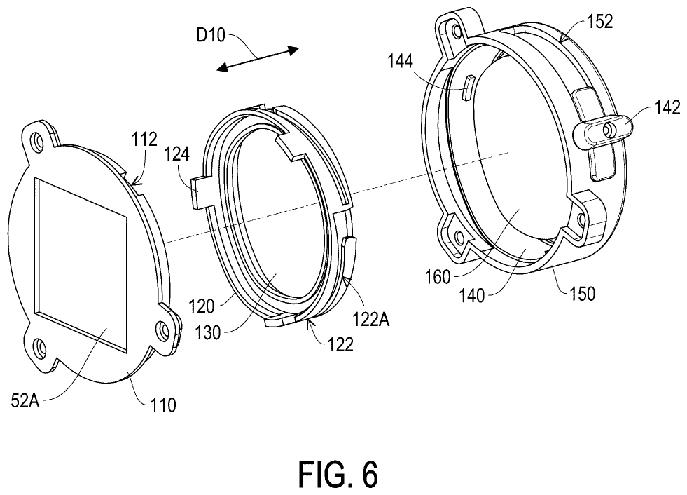

FIG. 6 is a schematic diagram of another viewing angle of the zoom lens module of FIG. 5 after being partially assembled again. Referring to FIG. 5 and FIG. 6, the second lens frame 150 has a circumferential groove 152. That is, the circumferential groove 152 is a strip opening extending along the outer peripheral wall of the second lens frame 150. The flexible zoom band 140 is suitable for being arranged inside the second lens frame 150. The flexible zoom band 140 has a sliding rod 142 on its outer side. The sliding rod 142 passes through the circumferential groove 152 and is adapted to slide along the circumferential groove 152. Therefore, by moving the sliding rod 142 exposed in the circumferential groove 152, the flexible zoom band 140 can be driven to rotate relative to the second lens frame 150.

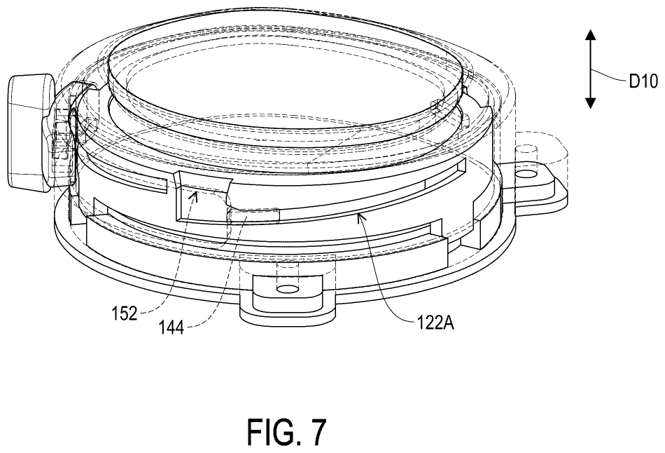

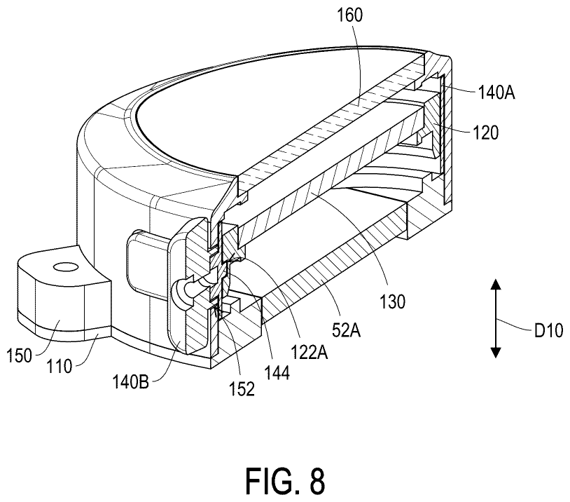

FIG. 7 is a partial perspective view of the zoom lens module of FIG. 2 in one state. FIG. 8 is a cross-sectional view of the zoom lens module of FIG. 7. FIG. 7 shows the first lens 130, the flexible zoom band 140, the second lens frame 150 and the second lens 160 in perspective, so as to clearly see the combination of the flexible zoom band 140 and the first lens frame 120 and the combination of the base 110 and the first lens frame 120. Referring to FIG. 5, FIG. 7, and FIG. 8, the first lens frame 120 is slidably assembled to the base 110. The first lens frame 120 is adapted to slide relative to the base 110 along the zoom direction D10. The outer peripheral wall 122 has an oblique guide groove 122A. The flexible zoom band 140 has a guide block 144 on its inner side. The guide block 144 is embedded in the oblique guide groove 122A and is adapted to slide along the oblique guide groove 122A. The second lens frame 150 is assembled to the base 110. That is, the relative position and distance between the second lens 160 on the second lens frame 150 and the display 52A on the base 110 are fixed.

The first lens frame 120 is located between the base 110 and the second lens frame 150. The flexible zoom band 140 is located between the second lens frame 150 and the first lens frame 120. Specifically, in the zoom direction D10, the first lens frame 120 is sandwiched between the base 110 and the second lens frame 150. In the circumferential direction, the first lens frame 120 surrounds a portion of the base 110, the flexible zoom band 140 surrounds the first lens frame 120, and the second lens frame 150 surrounds the flexible zoom band 140. As can be seen from FIG. 7, in this state, the guide block 144 inside the flexible zoom band 140 is located on the lower side of the oblique guide groove 122A on the left side in FIG. 7. The relative position of the second lens frame 150 and the base 110 is fixed, and the movement of the flexible zoom band 140 in the zoom direction D10 is also limited by the second lens frame 150 and the base 110. Therefore, when the guide block 144 of the flexible zoom band 140 is located on the lower side of the oblique guide groove 122A, the first lens frame 120 is maintained on the higher side in FIG. 7, that is, the first lens 130 is relatively close to the second lens 160.

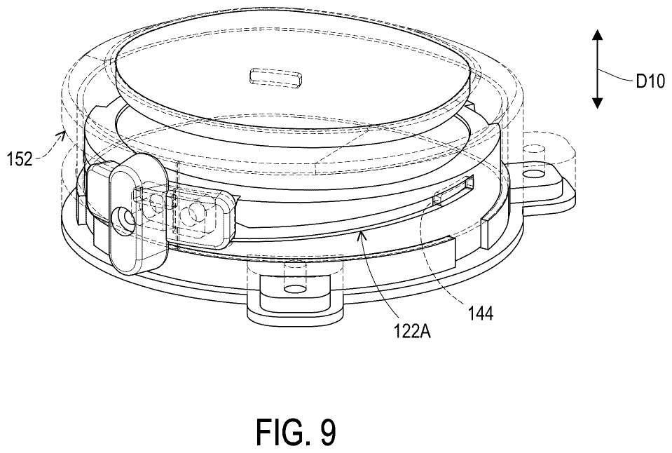

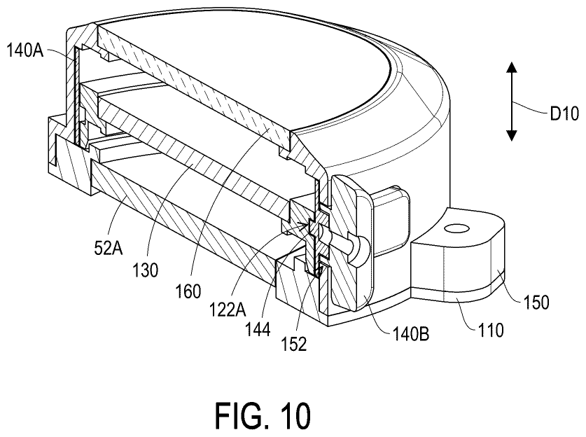

FIG. 9 is a partial perspective view of the zoom lens module of FIG. 2 in another state. FIG. 10 is a cross-sectional view of the zoom lens module of FIG. 9. Referring to FIG. 5, FIG. 9 and FIG. 10, when the sliding rod 142 is forced to drive the flexible zoom band 140 to slide on the outer peripheral wall 122, the guide block 144 drives the first lens frame 120 to slide in the zoom direction D10. Specifically, when the sliding rod 142 is forced to drive the flexible zoom band 140 to slide from the position of FIG. 7 to the position of FIG. 9, the guide block 144 moves to the right side from the lower position of the oblique guide groove 122A on the left side in FIG. 7, and the guide block 144 may, for example, stay on the higher side of the oblique guide groove 122A on the right side in FIG. 9. During the process of the guide block 144 of the flexible zoom band 140 moving toward the higher side of the right side of the oblique guide groove 122A, the guide block 144 may exert force on the wall of the oblique guide groove 122A to push the first lens frame 120. Although the first lens frame 120 cannot rotate, the first lens frame 120 may move toward the bottom of FIG. 9 in the zoom direction D10, that is, the first lens 130 may move away from the second lens 160 in the zoom direction D10.

In this way, in the head-mounted display device 50 and the zoom lens module 100 of the embodiment, as long as the sliding rod 142 is moved to drive the flexible zoom band 140 to rotate, the relative distance between the first lens 130 and the second lens 160 in the zoom direction D10 can be changed to achieve the purpose of zooming. Therefore, not only can the non-circular first lens 130 and the second lens 160 be used so that the zoom lens module 100 can be closer to the user's eyes, thereby enlarging the lens area and increasing the viewing angle, but also maintaining the zoom function. For example, the outer contours of the two zoom lens modules 100 in FIG. 1 are flatter on the side closer to the user's glabella. For users whose glabella is relatively prominent, the zoom lens module 100 can be closer to the user's eyes.

In addition, referring to FIG. 1 and FIG. 2, in the head-mounted display device 50 of the embodiment, the two zoom lens modules 100 can perform zooming independently. When users have myopia problems, they can zoom the zoom lens module 100 to obtain clear images. Moreover, even if the user's eyes have different degrees of myopia, the two zoom lens modules 100 can be individually zoomed to different degrees, so that both eyes can obtain clear images.

Referring to FIG. 5 again, in the embodiment, the number of the guide blocks 144 is plural, and the number of the oblique guide grooves 122A corresponds to the number of the guide blocks 144. The number of the oblique guide grooves 122A is larger and evenly distributed on the entire first lens frame 120, which can make the first lens frame 120 slide more smoothly relative to the base 110. In the embodiment, the material of the flexible zoom band 140 may be nylon, metal, or other materials that are flexible but not easily compressed in the length direction to change length. In the embodiment, the flexible zoom band 140 includes a band body 140A. The band body 140A surrounds the outer peripheral wall 122. Two ends of the band body 140A are adjacent to each other. That is, the flexible zoom band 140 can be formed into a circle by the band body 140A, which is originally a straight strip. Such a design is easy to manufacture and assemble, which can save costs. In the embodiment, the flexible zoom band 140 can further include a rod body 140B. The rod body 140B is connected to both ends of the band body 140A and serves as the sliding rod 142. The rod body 140B can not only be used to connect the two ends of the band body 140A, but also pass through the circumferential groove 152 to serve as the sliding rod 142.

In the embodiment, the first lens frame 120 has a plurality of sliders 124, and the base 110 has a plurality of slide grooves 112 corresponding to the sliders 124. Each slider 124 is slidably disposed within a slide groove 112 so as to be adapted to slide relative to the base 110 along the zoom direction D10.

In summary, in the head-mounted display device and the zoom lens module of the application, the outer peripheral wall of the first lens frame is irregularly shaped and is suitable for fixing irregularly shaped lenses, and the flexible zoom band is flexible so as to slide snugly on the outer peripheral wall of the first lens frame. Therefore, the area of the lens can be increased to increase the viewing angle, and it also has the zoom function.

What is claimed is:

1. A head-mounted display device, comprising:
a body, having two displays corresponding to both eyes;
a fixing device, adapted to fix the body to a user's head;
two zoom lens modules, wherein each of the zoom lens modules comprises:
a base, assembled to the body and corresponds to one of the two displays;
a first lens frame, slidably assembled to the base, wherein the first lens frame is adapted to slide relative to the base along a zoom direction, an outer peripheral wall of the first lens frame has various curvature radii, and the outer peripheral wall has an oblique guide groove;
a first lens, assembled to the first lens frame;
a flexible zoom band, surrounds the outer peripheral wall and is adapted to slide snugly on the outer peripheral wall, wherein the outside of the flexible zoom band has a sliding rod, the inside of the flexible zoom band has a guide block, the guide block is embedded in the oblique guide groove and is adapted to slide along the oblique guide groove;
a second lens frame, assembled to the base, wherein the first lens frame is located between the base and the second lens frame, the flexible zoom band is located between the second lens frame and the first lens frame, the second lens frame has a circumferential groove, the sliding rod passes through the circumferential groove and is adapted to slide along the circumferential groove; and
a second lens, assembled to the second lens frame, wherein when the sliding rod is driven by force to drive the flexible zoom band to slide on the outer peripheral wall, the guide block drives the first lens frame to slide in the zoom direction.

2. The head-mounted display device according to claim 1, wherein the material of each flexible zoom band comprises nylon or metal.

3. The head-mounted display device according to claim 1, wherein each of the flexible zoom band comprises a band body, the band body surrounds the outer peripheral wall, and two ends of the band body are adjacent to each other.

4. The head-mounted display device according to claim 3, wherein each of the flexible zoom band further comprises a rod body, the rod body is connected to the two ends of the band body and serves as the sliding rod.

5. The head-mounted display device according to claim 1, wherein the number of the guide blocks is plural, and the number of the oblique guide grooves corresponds to the number of the guide blocks.

6. A zoom lens module, comprising:
a base;
a first lens frame, slidably assembled to the base, wherein the first lens frame is adapted to slide relative to the base along a zoom direction, an outer peripheral wall of the first lens frame has various curvature radii, and the outer peripheral wall has an oblique guide groove;
a first lens, assembled to the first lens frame;
a flexible zoom band, surrounds the outer peripheral wall and is adapted to slide snugly on the outer peripheral wall, wherein the outside of the flexible zoom band has a sliding rod, the inside of the flexible zoom band has a guide block, the guide block is embedded in the oblique guide groove and is adapted to slide along the oblique guide groove;
a second lens frame, assembled to the base, wherein the first lens frame is located between the base and the second lens frame, the flexible zoom band is located between the second lens frame and the first lens frame, the second lens frame has a circumferential groove, the sliding rod passes through the circumferential groove and is adapted to slide along the circumferential groove; and
a second lens, assembled to the second lens frame, wherein when the sliding rod is driven by force to drive the flexible zoom band to slide on the outer peripheral wall, the guide block drives the first lens frame to slide in the zoom direction.

7. The zoom lens module according to claim 6, wherein the material of the flexible zoom band comprises nylon or metal.

8. The zoom lens module according to claim 6, wherein the flexible zoom band comprises a band body, the band body surrounds the outer peripheral wall, and two ends of the band body are adjacent to each other.

9. The zoom lens module according to claim 8, wherein the flexible zoom band further comprises a rod body, the rod body is connected to the two ends of the band body and serves as the sliding rod.

10. The zoom lens module according to claim 9, wherein the number of the guide blocks is plural, and the number of the oblique guide grooves corresponds to the number of the guide blocks.
